(19) United States
(12) Patent Application Publication
(10) Pub. No.: US 2019/0374965 A1
(43) Pub. Date: Dec. 12, 2019

(54) ATOMIZATION APPARATUS

(71) Applicant: SHENZHEN DANYA TECHNOLOGY CO., LTD., Shenzhen (CN)

(72) Inventors: Shuyun HU, Shenzhen (CN); Zhenqing LIN, Shenzhen (CN)

(73) Assignee: SHENZHEN DANYA TECHNOLOGY CO., LTD., Shenzhen (CN)

(21) Appl. No.: 16/426,110

(22) Filed: May 30, 2019

(30) Foreign Application Priority Data
Jun. 7, 2018 (CN) 201820876699.1

(51) Int. Cl. B05B 7/24

(52) U.S. Cl. CPC B05B 7/2421

(57) ABSTRACT

The present disclosure provides an atomization apparatus, which relates to the field of aromatherapy equipment. The atomization apparatus may include a body having an internal cavity, a reservoir chamber disposed in the internal cavity, a spacer disposed above the reservoir chamber, and an oil cup. The spacer and a top wall of the internal cavity may form an atomized gas passage. The atomized gas passage may be communicated with a nozzle of the body. The oil cup may be disposed inside the reservoir chamber and located outside a projection of the spacer onto the reservoir chamber. A bottom of the oil cup may be communicated with the reservoir chamber.

### CROSS-REFERENCE TO RELATED APPLICATIONS

This application claims priority to Chinese Application No. 201820876699.1, filed on Jun. 7, 2018, the contents of which are incorporated herein by reference in their entirety.

### TECHNICAL FIELD

The present disclosure relates to the field of aromatherapy equipment, in particular to an atomization apparatus.

### BACKGROUND

Aromatherapy machine is an aromatherapy equipment, which generally uses high-frequency oscillation such as ultrasonic vibration to atomize water mixed with an essential oil and release it into the air to make the air full of fragrance. The existing aromatherapy machine generally uses the method of dripping oil to add the essential oil to the water at one time. As a result, the concentration of the fragrance released by the aromatherapy machine becomes less and less over time, and the customer's experience is poor. In order to enhance the customer's experience, there is also a way of continuously supplying essential oil. An oil cup containing an essential oil can be disposed in the aromatherapy machine, and the oil cup can continuously supply the essential oil to the water to reduce the fluctuation of the fragrance concentration. However, in this way, the water droplets in the atomized vapor easily drop into the oil cup, which affects the purity of the essential oil and is not conducive to the maintenance of the fragrance concentration.

### SUMMARY

An atomization apparatus is provided in the present disclosure, which can reduce the influence of water droplets and water mist on the concentration of essential oil in the oil cup, and can ensure that the concentration of the essential oil is constant. The atomization apparatus may utilize the principle of water-oil balance to continuously and stably provide the fragrance. The present disclosure adopts the following technical solutions.

According to an aspect of the present disclosure, an atomization apparatus may include: a body, having an internal cavity; a reservoir chamber, disposed in the internal cavity; a spacer, disposed above the reservoir chamber, wherein the spacer and a top wall of the internal cavity may form an atomized gas passage, and the atomized gas passage may be communicated with the opening of the body; and an oil cup, disposed inside the reservoir chamber and located outside a projection of the spacer onto the reservoir chamber. A bottom of the oil cup may be communicated with the reservoir chamber.

In some embodiments, the spacer may extend downwardly from an internal top wall of the internal cavity to form a baffle, which may be enclosed peripherally with an opening on a bottom of the baffle. In some embodiments, a plane on which the bottom end of the baffle is located may be lower than a plane on which a top end of the oil cup is located.

In some embodiments, the oil cup may include an oil cup body having a flared opening that spreads outward.

In some embodiments, a cross-sectional area of the oil cup body may be substantially same.

In some embodiments, the oil cup may be integrally formed with the body or the oil cup may be disposed independently of the body.

In some embodiments, the body may include: a lower casing; a trough body, wherein the reservoir chamber may be an internal space surrounded by a side wall of the trough body disposed on the lower casing, and a fixing device for fixing the oil cup may be disposed in the trough body, the fixing device being located outside a projection of the spacer onto the trough body; and an upper cover, detachably connected to the trough body. The internal cavity may be formed between the upper cover and the trough body.

In some embodiments, the fixing device may be a fixing base disposed on a bottom plate of the trough body and matching with a shape of the oil cup. A first snapping block may be disposed on an internal wall of the fixing base. The first snapping block may be configured to maintain a predetermined distance between a bottom end of the oil cup and the bottom plate of the trough body. The fixing base may maintain the communication between the bottom of the oil cup and the trough body. Alternatively, the fixing device may be a fixing clip disposed on a sidewall of the trough body. A clip mouth of the fixing clip may match with the shape of the oil cup.

In some embodiments, a plurality of first engaging parts may be disposed on an outer side surface of a bottom plate of the trough body, and a plurality of second engaging parts may be disposed at positions corresponding to the plurality of first engaging parts in the lower casing. The plurality of first engaging parts may structurally match with the plurality of second engaging parts, and the trough body may be affixed to the lower casing when the plurality of first engaging parts are engaged with the plurality of second engaging parts.

In some embodiments, a through hole may be disposed on a bottom of the trough body and located inside a projection of the opening onto the bottom plate of the trough body, and an atomizing sheet may be disposed inside the through hole. The atomization apparatus may further include a muffling component disposed at an upper end of a central axis of the atomizing sheet and is internally located relative to a flanking side of the spacer.

In some embodiments, the edge of the side wall of the trough body may extend outward to form a bent edge, and the bent edge may be engaged with the lower casing.

In some embodiments, the body may further include an upper casing disposed outside the upper cover and the trough body. A first air flow passage may be formed between an external portion of the upper cover, the bent edge, and the upper casing. The lower casing and the internal side of the bent edge may form a second air flow passage. A first vent may be disposed on the bent edge, and the first vent may communicate the second airflow passage with the first airflow passage. A second vent may be disposed on the upper cover, and the second vent may communicate the first airflow passage and the internal cavity. The lower casing may be provided with a third vent that communicates the first airflow passage with external air.

In some embodiments, the lower end of the upper cover may be convexly provided with a card protrusion, and the card protrusion may be engaged with the internal wall of the upper casing. A limiting block may protrude from an upper end of the upper cover, and the limiting block may be engaged with an internal wall of the upper casing.

In some embodiments, a noise reduction bracket may be convexly disposed on the top wall of the internal cavity and may be internally located relative to the flanking side of the spacer. A top end of the noise reduction bracket may direct towards the nozzle. A bottom end of the noise reduction bracket may direct towards the atomizing sheet. A top end of the muffling component may be engaged with the noise reduction bracket.

In some embodiments, the body may further include an upper casing. The upper casing and the lower casing may form an external housing of the atomization apparatus. The upper casing may cover the upper cover and the trough body.

In some embodiments, there may be a preset distance between a bottom of the spacer and a liquid level of the reservoir chamber.

In some embodiments, the spacer may be a non-enclosed baffle, and the oil cup and the atomized gas passage may be disposed on different sides of the spacer, respectively.

In some embodiments, a protruded water level board having a scale may be disposed in the reservoir chamber. The scale may be configured to indicate a volume of a liquid contained in the reservoir chamber.

According to another aspect of the present disclosure, an atomization apparatus may include: a body, having an internal cavity; a reservoir chamber, disposed inside the internal cavity; an oil cup, disposed inside the reservoir chamber and a bottom of the oil cup communicated with the reservoir chamber; an isolation cover, disposed on an upper part of the oil cup. In some embodiments, the isolation cover may maintain a communication between an opening at a top of the oil cup and the internal cavity. A plane on which a lower end of the isolation cover is located may be lower than a plane on which an upper end of the oil cup is located.

The present disclosure provides an atomization apparatus that may have one or more following advantageous effects, and/or other advantageous effects. The internal cavity of the atomization apparatus may be provided with a spacer. The spacer and the top wall of the internal cavity may form an atomized gas passage. The atomized gas in the reservoir chamber may be sprayed out of the nozzle through the atomized gas passage under the guidance of the spacer. The droplets condensed by the atomized gas in the atomized gas passage may adhere to the side wall of the spacer and slide from the side wall of the spacer into the reservoir chamber. The oil cup may be located outside a projection of the atomized gas passage onto the bottom of the internal cavity and the spacer may prevent the liquid in the atomized gas from dripping into the oil cup. Therefore, the concentration of the essential oil in the oil cup may be kept constant, and the principle of water and oil balance may be used to ensure that the oil cup continuously and uniformly supplies the essential oil, thereby ensuring a stable and stable supply of fragrance of the atomization apparatus. In addition, the condensed droplets may slide down the side wall of the spacer into the reservoir chamber, which may also reduce noise and improve the user experience.

The present disclosure also provides another atomization apparatus, which is provided with an isolation cover on the upper part of the oil cup to prevent the liquid from dripping into the oil cup when the atomized gas is liquefied on the top wall of the internal cavity. Therefore, the concentration of the essential oil in the oil cup may be kept constant, and the principle of water-oil balance may be used to ensure that the oil cup continuously and uniformly supplies the essential oil. The atomization apparatus may continuously and stably provide the fragrance.

### BRIEF DESCRIPTION OF THE DRAWINGS

FIG. 1 is an exploded view of an atomization apparatus;

FIG. 2 is a cross-sectional view of the atomization apparatus;

FIG. 3 is a schematic structural diagram 1 of the muffling component;

FIG. 4 is a schematic structural diagram 2 of the muffling component;

FIG. 5 is a schematic structural view of a trough body;

FIG. 6 is a schematic structural view of a trough body and an oil cup;

FIG. 7 is an exploded view of the trough body and the oil cup;

FIG. 8 is a schematic structural diagram 1 of an upper cover;

FIG. 9 is a schematic structural diagram 2 of an upper cover; and

FIG. 10 is a cross-sectional view of the atomization apparatus.

Description of reference signs in the figures: 1, lower casing; 2, trough body; 21, reservoir chamber; 22, bent edge; 221, first vent; 23, fixing base; 231, first snapping block; 24, through hole; 25, protruded water level board; 3, upper cover; 31, spacer; 32, protrude snapping part; 33, limiting block; 34, noise reduction bracket; 35, second vent; 36, isolation cover; 4, oil cup; 5, upper casing; 51, nozzle; 6, muffling component; 61, mist pore; 62, slit; and 7, electrical component.

### DETAILED DESCRIPTION

In order to explain the technical problems, the technical solutions, and the technical effects in the present disclosure more clearly, the technical solutions of the present disclosure will be further described below with reference to the accompanying drawings.

### Embodiment 1

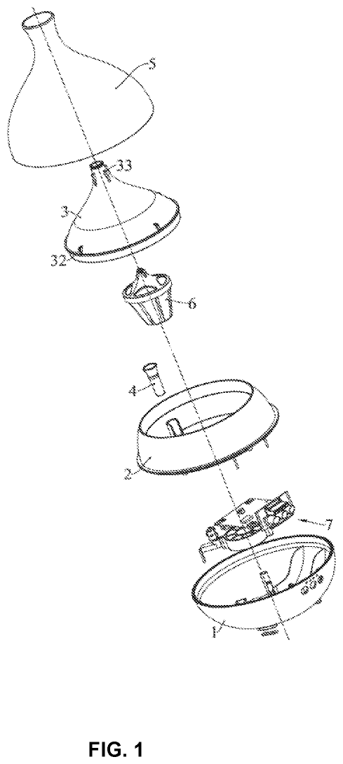

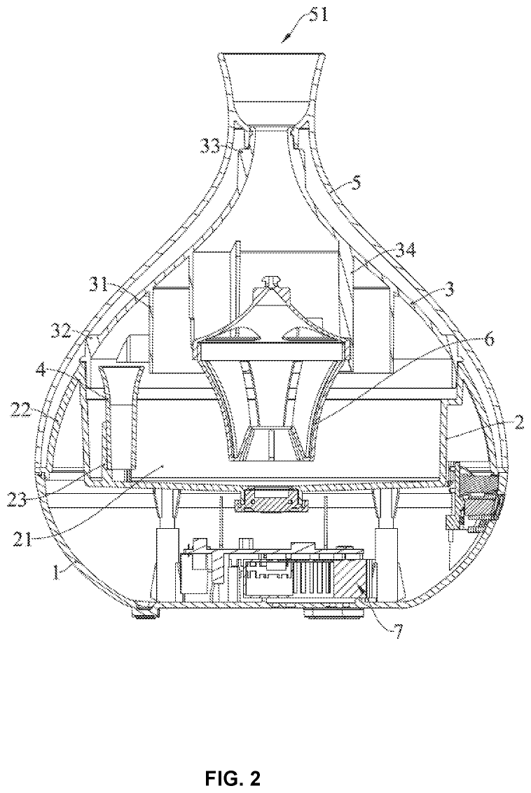

As shown in FIGS. 1 and 2, the present embodiment provides an atomization apparatus for atomizing a liquid such as water mixed with oil and releasing the mist containing small drops of the liquid into the air, thus improving the smell of the environment with a fragrance. The atomization apparatus includes a body and an oil cup 4. The body forms the main structure of the atomization apparatus, and the internal cavity is disposed in the body. The internal cavity includes a reservoir chamber 21 for containing a liquid. For example, the liquid may be pure water, water mixed with an essential oil, or other liquids, which is not limited herein. The oil cup 4 is placed in the reservoir chamber 21 for containing the essential oil. The top and bottom of the oil cup 4 are provided with openings, and the opening at the top of the oil cup 4 can be used to add the essential oil. When in use, the opening at the bottom of the oil cup 4 is immersed in the liquid.

The atomization apparatus also includes an atomizing component, which may be an atomizing sheet. The atomizing sheet may atomize the liquid in the reservoir chamber 21. The body is also provided with a nozzle 51 communicated with the internal cavity. When the atomization apparatus is in operation, the atomizing sheet atomizes the liquid in the internal cavity, and the atomized gas is discharged outward through the nozzle 51.

When using the atomization apparatus, it may be needed to add a liquid such as water to the reservoir chamber 21 in advance, and the level of the liquid should not be lower than the opening at the bottom of the oil cup 4. Then the essential oil may be added to the oil cup 4 through the opening at the upper end of the oil cup 4 so as to ensure that the level of the essential oil in the oil cup 4 is higher than the level of the liquid in the internal cavity. Since the compatibility of the essential oil with water is relatively low, the essential oil does not dissolve in the water. With the consumption of liquid in the reservoir chamber 21, there is a certain pressure difference between the essential oil and the liquid in the reservoir chamber 21. Under the pressure difference, the essential oil in the oil cup 4 flows into the reservoir chamber 21 from the opening at the lower end of the oil cup 4 until the pressure at the contact surface is balanced. Based on the relatively low compatibility between the essential oil and the water, and the principle of liquid pressure balance, the purpose of continuously supplying the essential oil into the reservoir chamber 21 is achieved, and the fluctuation of the concentration of the essential oil in the water is reduced, so that the fragrance of the atomized gas remains stable and the user experience is improved.

When the liquid in the reservoir chamber 21 is atomized, the atomized gas condenses into droplets on the top wall of the internal cavity and fall down. Thus, in order to prevent the liquid from dripping into the oil cup 4, the atomization apparatus is provided with a spacer 31. The spacer 31 prevents the dripping of a liquid water formed by the condense of water vapor from the reservoir chamber that may affect the concentration of the essential oil, and ensures that the concentration of the essential oil in the oil cup 4 does not substantially change. Specifically, the spacer 31 is disposed above the reservoir chamber 21 and forms an atomized gas passage with the internal top wall of the internal cavity. The atomized gas passage communicates with the nozzle 51 on the body, and the atomized gas is discharged through the atomized gas passage and the nozzle 51. On the one hand, the spacer 31 prevents the dripping of a liquid water formed by the condense of water vapor from the reservoir chamber that may affect the concentration of the essential oil. On the other hand, the spacer 31 may guide the atomized gas.

When the atomization apparatus is working normally, the atomized gas is sprayed out of the nozzle 51 through the atomized gas passage under the guidance of the spacer. The droplets condensed by the atomized gas in the atomized gas passage are attached to the side wall of the spacer 31, and then slide into the reservoir chamber 21 along the side wall of the spacer 31, thereby reducing the noise caused by the droplets in the atomized gas passage falling directly into the reservoir chamber 21. The oil cup 4 is located outside the atomized gas passage and is located outside a projection of the atomized gas passage onto the bottom of the internal cavity, and the spacer 31 may prevent the liquid in the atomized gas from dripping into the oil cup 4. In addition, the concentration of the essential oil in the oil cup 4 is kept constant, and the principle of water-oil balance is used to allow the atomization apparatus to continuously and stably provide the fragrance.

In this embodiment, the spacer 31 may extend downwardly from an internal top wall of the internal cavity to form a baffle, which is enclosed peripherally with an opening on a bottom of the baffle. The baffle may be an annular cylindrical structure, and the atomized gas flows from the internal hole of the cylindrical structure to the nozzle 51 under the guidance of the spacer 31 of the cylindrical structure. In order to further prevent the water mist or water droplets in the atomized gas from affecting the concentration of the essential oil in the oil cup 4, a plane on which the bottom end of the baffle is located may be lower than a plane on which the top end of the oil cup is located, which may achieve a better effect of the separation of the essential oil from the water mist or water droplets.

In order to allow the atomized gas in the internal cavity to enter the atomized gas passage formed by the spacer 31 and the internal wall of the internal cavity, there may a preset distance between the bottom of the spacer 31 and the liquid level of the reservoir chamber 21, so as to allow the gas outside the spacer 31 to enter the atomized gas passage. Optionally, the preset distance between the bottom end of the spacer 31 and the liquid surface may vary between 3-5 mm.

In some embodiments, the spacer 31 may be a non-enclosed plate-like structure, such as a flat plate or a curved plate, which may divide the internal cavity into two parts. The flat or curved plate forms an atomized gas passage with the top and a portion of the sidewall of the internal cavity. The oil cup 4 and the atomized gas passage are respectively located on both sides of the flat plate or the curved plate. In this manner, it is also possible to prevent the liquid droplets from falling into the oil cup 4, thereby ensuring the stability of the concentration of the essential oil in the oil cup 4.

In this embodiment, a muffling component 6 is disposed in the internal cavity, and a muffling component 6 is disposed at an upper end of a central axis of the atomizing sheet and is internally located relative to a flanking side of the spacer 31. The lower end of the muffling component 6 is immersed in the liquid, and the muffling component 6 reduces the sound of the water droplets falling on the water surface during the atomization, and the muffling component 6 has a guidance effect on the fallen water droplets, and thus the noise is reduced. As shown in FIG. 2, the top of the internal cavity is convexly provided with a noise reduction bracket 34. The noise reduction bracket 34 has a cylindrical structure and is disposed in the spacer 31. The upper end of the noise reduction bracket 34 is disposed opposite to the nozzle 51 and the lower end is opposite to the atomizing sheet. The upper end of the muffling component 6 is snapped into the noise reduction bracket 34.

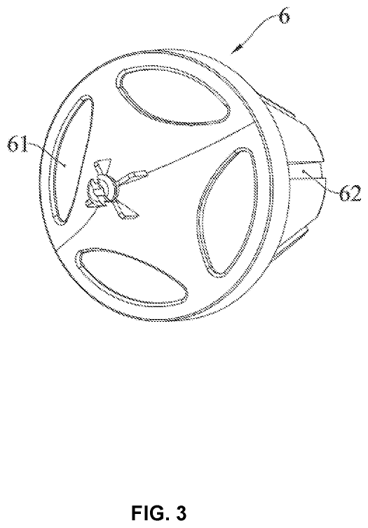

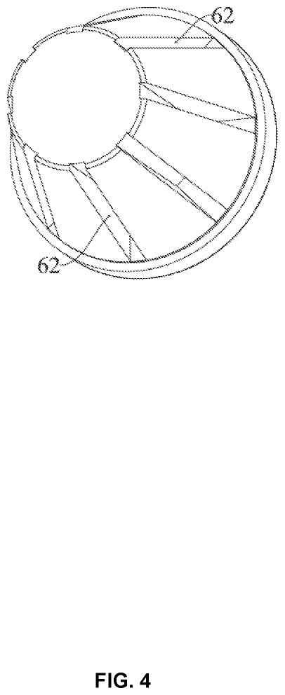

As shown in FIG. 3 and FIG. 4, the muffling component 6 is a hollow cover structure and includes a cover having a large opening at the upper end, a small opening at the lower end, and a cover connected to the cover body. A plurality of slits 62 extending in the axial direction are disposed on the circumferential surface of the cover body, and the cover is formed in an arc shape and provided with a plurality of mist holes 61. During the operation of the atomization apparatus, the atomized gas generated by the atomizing sheet enters the muffling component 6 through the slit 62, and the atomized gas is discharged through the mist hole 61. The liquid in the atomized gas contacts the cover to form water droplets, and slides along the internal wall of the cover and the cover body, which can effectively eliminate the noise of water droplets falling onto the water surface, reduce the noise, and improve the user experience.

In this embodiment, the muffling component 6 may also act as a guide for the atomized gas, and after the mist is guided through the muffling component 6, it is discharged by the nozzle 51. In addition, by setting spacer 31, the atomized gas in the spacer 31 moves upwards to contact the spacer 31, and the liquid in the atomized gas condenses and slides down into the water along the spacer 31. Secondary noise reduction may be achieved with the use of the muffling component 6. The noise of the atomization apparatus may be further reduced and the user experience may be improved.

In this embodiment, as shown in FIG. 1 and FIG. 2, the body includes a lower casing 1, a trough body 2, and an upper cover 3. The reservoir chamber 21 is an internal space surrounded by the side wall of the trough body 2, and the trough body 2 is detachably disposed on the lower casing 1, and the installation space for accommodating the electric component 7 is formed between the bottom of the trough body 2 and the lower casing 1. The upper cover 3 is detachably connected to the trough body 2, and an internal cavity is formed between the upper cover 3 and the trough body 2.

In this embodiment, by setting the trough body 2 and the lower casing 1 as detachably connected, rather than arranging the trough body 2 and the lower casing 1 in a one-piece structure, when the trough body 2 needs to be cleaned, the trough body 2 can be removed from the lower casing 1 and individually cleaned, thus avoiding contact between water and the electrical component 7 between the lower casing 1 and the trough body 2, thereby ensuring the safety of the electrical component 7. This makes it convenient to clean the trough body 2 and reduces the failure rate of the atomization apparatus.

For easy disassembly, the trough body 2 and the lower casing 1 may be fixed by snapping. Specifically, the outer side of the bottom body of the trough body 2 is provided with a plurality of first engaging parts, and the positions of the lower casing 1 corresponding to the first engaging parts are respectively provided with the second engaging parts structurally matching with the first engaging parts. The trough body 2 can be attached to the lower casing 1 by engaging the first engaging parts and the second engaging parts. In some embodiments, a first engaging part may be a cylinder, and the corresponding second engaging part may be a hollow cylinder. The cylinder may be inserted into the internal hole of the cylinder to fix the trough body 2 and the lower casing 1. In other embodiments, the first engaging part may be a hollow body, and correspondingly, the second engaging parts may be a cylinder. The fixation of the trough body 2 and the lower casing 1 may be achieved.

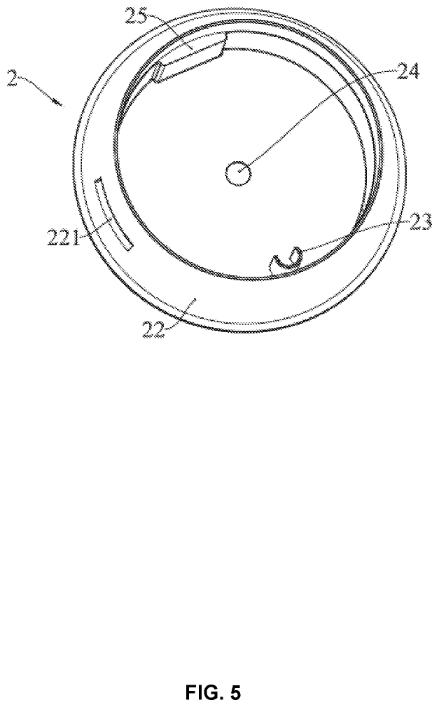

As shown in FIG. 2, FIG. 5-FIG. 7, the edge of the side wall of the trough body 2 extends outward to form a bent edge 22. In order to improve the fixing effect of the trough body 2 and the lower casing 1, the end of the bent edge 22 may be provided with an annular rib, and the end surface of a side of the lower casing 1 is correspondingly provided with a card slot, and the rib and the card slot may increase the firmness of the fixation between the body 2 and the lower casing 1. In other embodiments, the bent edge 22 may be provided with a card slot, and correspondingly, the lower casing 1 may be provided with a rib.

The bottom plate of the trough body 2 is provided with a through hole 24 which is located inside a projection of the nozzle 51 onto the bottom plate of the trough body 2, and an atomizing sheet is disposed in the through hole 24, which makes it convenient for the atomized gas generated by the atomizing sheet to directly enter the atomized gas passage.

In this embodiment, the oil cup 4 includes an oil cup body and a flared fuel filler port. The oil cup body is connected to the end of the flare fuel filler port. By setting the flared fuel filler port, it is convenient for the user to drip the essential oil into the oil cup 4. The oil cup 4 may also be provided with a tick mark, and the maximum scale is disposed at the upper end, for example, the connection of the flared fuel filler port and the oil cup body, to facilitate identification of the loaded essential oil capacity. Alternatively, the oil cup 4 may also have other shapes, such as cube tubes, tapered tubes, and the like.

In this embodiment, the cross-sectional area of the oil cup body is substantially the same, which may ensure that the amount of the essential oil added to the reservoir chamber 21 by the oil cup 4 is constant. This may be advantageous for maintaining the aroma concentration of the atomization apparatus to be stable.

Alternatively, the oil cup 4 may be integrally formed with the body or may be disposed independently of the body. When the oil cup 4 is integrally formed with the body, in order to facilitate the addition of the essential oil to the oil cup 4, the oil storage pipe 4 may be integrally provided with the trough body 2, and the bottom end of the oil cup 4 is provided with an oil hole so that the essential oil in the oil cup 4 is added to the reservoir chamber 21 through the oil hole. In order to reduce the residual oil in the oil cup 4, the oil outlet may extend upward along the bottom of the side wall of the oil cup 4, which may ensure that the essential oil at the bottom of the oil cup 4 can smoothly enter the reservoir chamber 21. The oil cup 4 may be integrated with the trough body 2, so the oil cup 4 does not need to be set alone. It is more convenient to use the atomization apparatus.

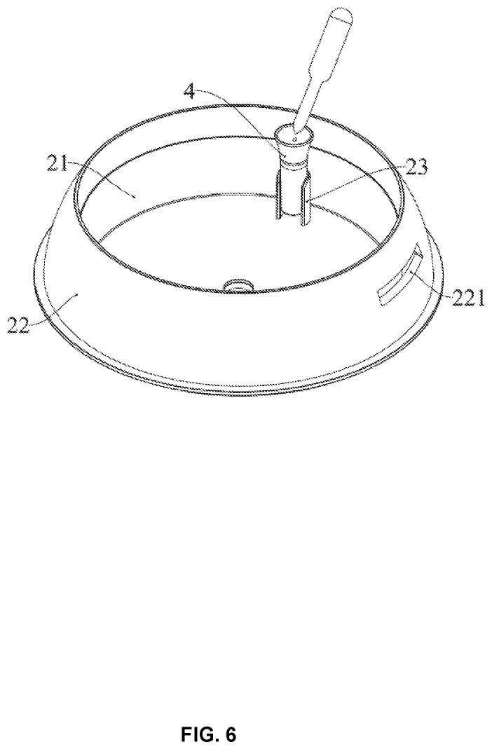

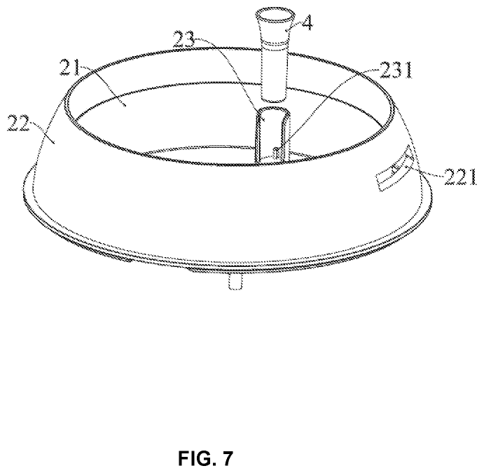

In this embodiment, the oil cup 4 is disposed independently of the body. Specifically, the fixing chamber 21 is further provided with a fixing device for fixing the oil cup 4, and the fixing device is located outside a projection of the spacer 31 onto the trough body. As shown in FIG. 6 and FIG. 7, the fixing device is a fixing base 23 that is disposed on the bottom plate of the trough body 2 and matches with the shape of the oil cup 4. The fixing base 23 is set to a semi-cylindrical shape, and it is ensured that when the oil cup 4 is fixed on the fixing base 23, the bottom of the oil cup 4 communicates with the internal cavity. In other embodiments, the fixing base 23 may also be a columnar structure that suits the oil cup 4. The bottom of the columnar structure is provided with a notch to ensure that the bottom of the oil cup 4 is in communication with the internal cavity.

The fixing base 23 is disposed at the side wall of the reservoir chamber 21 to prevent the oil cup 4 from affecting the atomization effect of the atomizing sheet located at the middle of the reservoir chamber 21, and the oil cup 4 is disposed at the side of the reservoir chamber 21. When the user adds the essential oil to the side of the position of the oil cup 4, the user's field of vision is relatively wide, and the user's line of sight may be substantially parallel with the scale line on the oil cup 4, so that the amount of the added essential oil is more accurate. In addition, the fixing base 23 is disposed at the side wall of the trough body 2 and is semi-cylindrical. When the oil cup 4 is removed, there is no hidden corner position in the trough body 2, which contributes to easy cleaning. In order to install the oil cup 4 to the fixing base 23, the bottom of the oil cup 4 is kept at a certain distance (for example, 4-5 mm) from the bottom surface of the reservoir chamber 21, and the bottom portion of the internal side wall of the fixing base 23 is also provided with a first snapping block 231 having a certain height. When the oil cup 4 is installed, the bottom of the oil cup 4 abuts the first snapping block 231 to ensure that the distance between the bottom end of the oil cup 4 and the bottom plate of the reservoir chamber 21 is set to allow the bottom of the oil cup 4 to communicate with the trough body 2.

In other embodiments, the fixing device may also be a fixing clip disposed on the side wall of the trough body 2, and the clip of the holder matches the shape of the oil cup 4. When fixing the oil cup 4 with the fixing clip, it is possible to set the distance between the bottom of the ensure oil cup 4 and the bottom plate of the trough body 2 by adjusting the position of the collet and the oil cup 4.

In order to ensure that the amount of the added essential oil matches the amount of water contained in the reservoir chamber 21, a protruded water level board 25 is also disposed in the reservoir chamber 21. The protruded water level board 25 may be provided with a scale. The scale may be configured to indicate a volume of a liquid contained in the reservoir chamber. When the water and the essential oil are added, the amount of addition may be accurately determined by the corresponding scale.

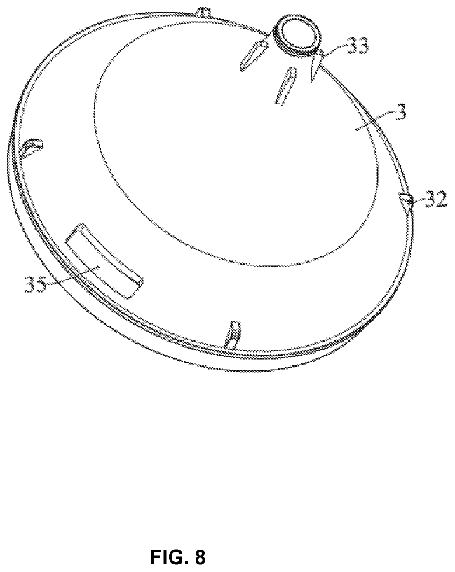

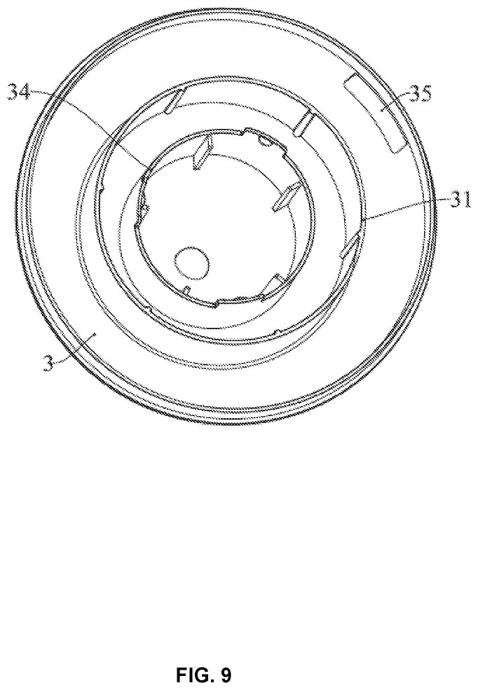

In this embodiment, the body further includes an upper casing 5, and the upper casing 5 and the lower casing 1 form an external housing of the atomization apparatus, and the upper casing 5 is disposed outside the upper cover 3 and the trough body 2, and covers the upper cover 3 and the trough body 2. The upper casing 5 is detachably connected to the upper cover 3, and when water or the essential oil needs to be added, the upper casing 5 is detached together with the upper cover 3. Specifically, as shown in FIG. 2, FIG. 8-FIG. 9, the top of the upper cover 3 is provided with a through hole, and the upper casing 5 is provided with a nozzle 51 at a position corresponding to the through hole. The lower end of the upper cover 3 is convexly provided with a protrude snapping part 32. When the upper casing 5 is disposed outside the upper cover 3, the protrude snapping part 32 is engaged with the internal wall of the upper casing 5 to fix the upper cover 3 and the upper casing 5 at together. In order to limit the depth of the through hole of the upper cover 3 in the upper casing 5 and prevent the through hole from extending out of the nozzle 51, the upper end of the upper cover 3 is also provided with a limiting block 33. The limiting block 33 is engaged with the internal wall of the upper casing 5 to restrict a location of the upper casing 5 relative to the upper cover 3. For example, the limiting block 33 prevents the upper casing 5 from moving town towards the upper cover 3, thereby preventing the through hole from protruding beyond the nozzle 51 and improving the appearance of the atomization apparatus. In this embodiment, there may be multiple protrude snapping parts 32 and limiting blocks 33 which are distributed along the circumferential direction of the upper cover 3. This may be advantageous to improve the uniformity of the force received by the upper cover 3 and the upper casing 5, and makes the fixation between the upper cover 3 and the upper casing 5 relatively stable so that the upper cover 3 and the upper casing 5 does not sway.

In order to maintain the air pressure balance in the atomization apparatus, as shown in FIG. 2, FIG. 7 and FIG. 8, a first air flow passage is formed between an external portion of the upper cover 3, the bent edge 22, and the upper casing 5. A second air flow passage is formed between the lower casing 1 and the internal side of the bent edge 22. A first vent 221 is disposed on the bent edge 22, and the first vent 221 communicates the second airflow passage with the first airflow passage. The upper cover 3 is provided with a second vent 35, and the second vent 35 connects the first air flow passage with the internal cavity. The lower casing 1 is provided with a third vent, and the third vent connects the first air passage with the external air. When the atomization apparatus is in operation, the external air enters the second air flow passage through the third air vent, and enters the first air flow passage through the first air vent 221. The gas then enters the internal cavity through the second vent 35, and the atomized gas atomized by the atomizing sheet is discharged through the through hole and the nozzle 51.

### Embodiment 2

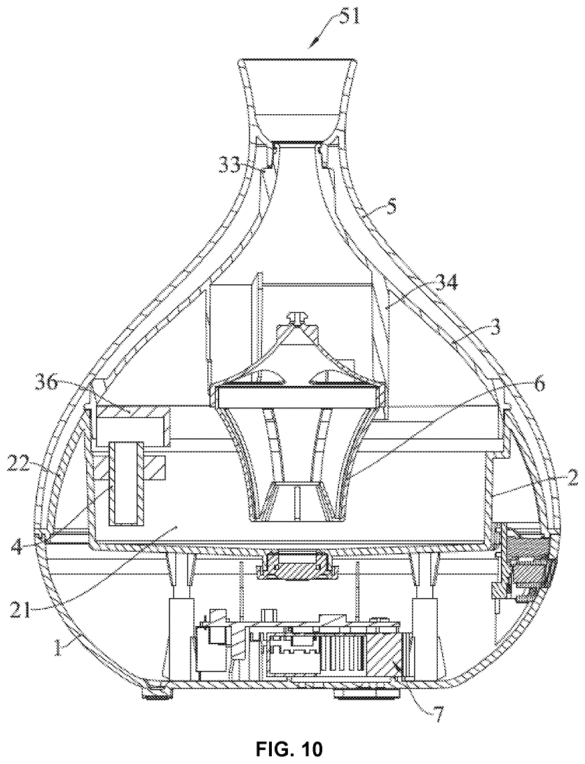

This embodiment provides an atomization apparatus, which is substantially similar to the atomization apparatus structure in Embodiment 1 and is different from Embodiment 1 in that, as shown in FIG. 10, an isolation cover 36 is disposed in the internal cavity. The isolation cover 36 is disposed on the upper portion of the oil cup 4, and ensures that the opening at the top of the oil cup 4 communicates with the internal cavity, so that the gas pressure of the upper oil of the oil cup 4 is the same as the gas pressure of the liquid in the internal cavity, and thus achieving continuous oil supply from the oil cup 4 to the reservoir chamber 21. In order to achieve a better effect for using separating the essential oil and water mist, a plane on which the lower end of the isolation cover 36 is located may be lower than a plane on which the upper end of the oil cup 4 is located. The upper end of the oil cup 4 is completely located in the isolation cover 36, and the internal cavity size of the isolation cover 36 is slightly larger than the cross-sectional dimension of the oil cup 4, so as to ensure that the opening at the top of the oil cup 4 is in communication with the internal cavity.

In some embodiments, the isolation cover 36 may be integrally formed with the cavity wall of the internal cavity. For example, the isolation cover 36 may be a tubular structure having a lower end opening formed by extending downward from the internal wall of the upper cover 3, or the isolation cover 36 may be a cover having a lower end that is integrally formed with the trough body 2 or the upper cover 3. The isolation cover 36 may also be an independently provided cover that is fixed to the trough body 2 or the upper cover 3 by snapping or screwing.

In order to simplify the internal structure of the atomization apparatus, in this embodiment, the isolation cover 36 is integrally formed with the cavity wall of the internal cavity, as shown in FIG. 10. By disposing the isolation cover 36 at the top of the oil cup 4, it is possible to prevent the liquid in the atomized gas from dripping into the oil cup 4 and ensure that the concentration of the essential oil in the oil cup 4 is substantially constant. The principle of water-oil balance may be used to allow the atomization apparatus to continuously and stably provide the fragrance.

The above contents describe exemplary embodiments of the present disclosure. The details of the present disclosure and the scope of the present disclosure are subject to change without departing from the spirit and scope of the present disclosure.

What is claimed is:

1. An atomization apparatus, comprising:
a body, having an internal cavity;
a reservoir chamber, disposed in the internal cavity;
a spacer, disposed above the reservoir chamber, wherein the spacer and a top wall of the internal cavity form an atomized gas passage, the atomized gas passage being communicated with a nozzle of the body; and
an oil cup, disposed inside the reservoir chamber and located outside a projection of the spacer onto the reservoir chamber, a bottom of the oil cup being communicated with the reservoir chamber.

2. The atomization apparatus of claim 1, wherein the spacer extends downwardly from an internal top wall of the internal cavity to form a baffle, which is enclosed peripherally with an opening on a bottom of the baffle, and wherein a plane on which the bottom end of the baffle is located is lower than a plane on which a top end of the oil cup is located.

3. The atomization apparatus of claim 1, wherein the oil cup comprises an oil cup body having a flared opening that spreads outward.

4. The atomization apparatus of claim 3, wherein a cross-sectional area of the oil cup body is substantially same.

5. The atomization apparatus of claim 1, wherein the oil cup is integrally formed with the body or the oil cup is disposed independently of the body.

6. The atomization apparatus of claim 1, wherein the body comprises:
a lower casing;
a trough body, wherein the reservoir chamber is an internal space surrounded by a side wall of the trough body disposed on the lower casing, and a fixing device for fixing the oil cup is disposed in the trough body, the fixing device being located outside a projection of the spacer onto the trough body; and
an upper cover, detachably connected to the trough body, wherein the internal cavity is formed between the upper cover and the trough body.

7. The atomization apparatus of claim 6, wherein the fixing device is a fixing base disposed on a bottom plate of the trough body and matching with a shape of the oil cup, wherein a first snapping block is disposed on an internal wall of the fixing base, the first snapping block being configured to maintain a predetermined distance between a bottom end of the oil cup and the bottom plate of the trough body, and wherein the fixing base maintains the communication between the bottom of the oil cup and the trough body; or
the fixing device is a fixing clip disposed on a sidewall of the trough body, wherein a clip mouth of the fixing clip matches with the shape of the oil cup.

8. The atomization apparatus of claim 6, wherein a plurality of first engaging parts are disposed on an outer side surface of a bottom plate of the trough body, and a plurality of second engaging parts are disposed at positions corresponding to the plurality of first engaging parts in the lower casing, wherein the plurality of first engaging parts structurally matches with the plurality of second engaging parts, and the trough body is affixed to the lower casing when the plurality of first engaging parts are engaged with the plurality of second engaging parts.

9. The atomization apparatus of claim 6, wherein a through hole is disposed on a bottom of the trough body and located inside a projection of the nozzle onto the bottom plate of the trough body, and an atomizing sheet is disposed inside the through hole; and
the atomization apparatus further comprises:
a muffling component, wherein the muffling component is disposed at an upper end of a central axis of the atomizing sheet and is internally located relative to a flanking side of the spacer.

10. The atomization apparatus of claim 9, wherein a noise reduction bracket is convexly disposed on the top wall of the internal cavity and is internally located relative to the flanking side of the spacer, wherein
a top end of the noise reduction bracket directs towards the nozzle;
a bottom end of the noise reduction bracket directs towards the atomizing sheet; and
a top end of the muffling component is engaged with the noise reduction bracket.

11. The atomization apparatus of claim 6, wherein an edge of the side wall of the trough body extends outward to form a bent edge, and the bent edge is engaged with the lower casing.

12. The atomization apparatus of claim 11, wherein the body further includes an upper casing, the upper casing and the lower casing forming an external housing of the atomization apparatus, wherein the upper casing covers the upper cover and the trough body.

13. The atomization apparatus of claim 12, wherein a first air flow passage is formed between an external portion of the upper cover, the bent edge, and the upper casing; and
a second air flow passage is formed between the lower casing and the internal side of the bent edge, wherein
a first vent disposed on the bent edge communicates the second airflow passage with the first airflow passage;
a second vent disposed on the upper cover connects the first air flow passage with the internal cavity; and
a third vent disposed on the lower casing connects the first air passage with the external air.

14. The atomization apparatus of claim 12, wherein a protrude snapping part is convexly disposed on a lower end of the upper cover, the protrude snapping part being engaged with the internal wall of the upper casing to fix the upper cover with the upper casing.

15. The atomization apparatus of claim 12, wherein a limiting block is disposed on an upper end of the upper cover and engaged with the internal wall of the upper casing, the limiting block configured to limit a location of the upper casing relative to the upper cover.

16. The atomization apparatus of claim 1, wherein there is a preset distance between a bottom of the spacer and a liquid level of the reservoir chamber.

17. The atomization apparatus of claim 1, wherein the spacer is a non-enclosed baffle, and the oil cup and the atomized gas passage are disposed on different sides of the spacer, respectively.

18. The atomization apparatus of claim 1, wherein a protruded water level board having a scale is disposed in the reservoir chamber, the scale configured to indicate a volume of a liquid contained in the reservoir chamber.

19. An atomization apparatus, comprising:
a body, having an internal cavity; a reservoir chamber, disposed inside the internal cavity;
an oil cup, disposed inside the reservoir chamber and a bottom of the oil cup communicating with the reservoir chamber;
an isolation cover, disposed on an upper part of the oil cup, wherein the isolation cover maintains a communication between an opening at a top of the oil cup and the internal cavity, and a plane on which a lower end of the isolation cover is located is lower than a plane on which an upper end of the oil cup is located.
